(19) United States
(12) Patent Application Publication
(10) Pub. No.: US 2003/0086681 A1
(43) Pub. Date: May 8, 2003

(54) Digital versatile disk player

(75) Inventor: Tamotsu Miyagawa, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 10/268,788

(22) Filed: Oct. 11, 2002

(30) Foreign Application Priority Data
Nov. 6, 2001 (JP) P 2001-340102

(51) Int. Cl. H04N 9/79; H04N 9/00

(52) U.S. Cl. 386/34; 386/39

(57) ABSTRACT

When a setup key is operated, a setup screen capable of setting and changing languages of a sound, a caption and a menu screen at once is displayed on a display apparatus 21. Here, when an up-and-down key is operated and a desired language is selected and a confirmation key is operated, the languages of the sound, the caption and the menu screen are set and changed at once. Therefore, operability of a user can be improved and these languages can be set simply.

### BACKGROUND OF THE INVENTION

This invention relates to a digital versatile disk player for reading and reproducing various data recorded on a digital versatile disk.

Conventionally, there was a DVD player for reading and reproducing data recorded on a digital versatile disk (hereinafter called DVD).

Video data, sound data, caption data and control data are recorded on the DVD with the data mixed in one track. The sound data and the caption data of plural languages such as Japanese, English, German and French are recorded on the DVD. The control data is data for directing reproduction timing of the video data, the sound data and the caption data read from the DVD, and is data which a DVD player uses for synchronizing the reproduction timing of the video data, the sound data and the caption data read from the DVD.

Incidentally, the video data, the sound data and the caption data are compressed and recorded on the DVD.

The DVD player reads the video data, the sound data and the caption data from the DVD set in a main body, and inputs a sound signal in which the sound data of the set language is expanded to a display apparatus, and also inputs a video signal with which a caption of the language set in the video data is combined to the display apparatus. Therefore, in the display apparatus, a sound (sound of the set language) according to the sound signal inputted from the DVD player is outputted from a speaker and also video based on the video signal inputted from the DVD player is displayed on a screen. A caption of the set language is combined with this video.

Also, the DVD player stores a setting menu screen for guiding a method of a setting operation with respect to a user in the case of making setting of various parameters with respect to the main body. The DVD player stores the setting menu screen by plural languages. The DVD player provides an on-screen display function (hereinafter called “OSD function”) for reading out the setting menu screen of the set language and inputting it to the display apparatus. Therefore, the setting menu screen of the set language is displayed on the display apparatus. A screen for guiding a method of a setting operation of languages of the sound, the caption and further this setting menu screen is also included in this setting menu screen.

However, the conventional DVD player had a configuration for setting a language one by one with respect to the sound, the caption and the setting menu screen. Because of this, there was a problem that a user must set a language one by one with respect to the sound, the caption and the setting menu screen at the time of purchase and a setting operation of this language is troublesome. Also, in the case of changing the language with respect to the sound and the caption during reproduction, after performing a change operation of the language with respect to the sound (or the caption), a change operation of the language must be performed with respect to the caption (or the sound) in which the change operation of the language is not performed and a setting operation of the language of the sound and the caption at the time of reproduction was troublesome.

For example, a configuration in which a screen for setting a language of a sound or a caption is displayed along with a title menu in order to cause a user to recognize the setting contents before reproduction is described in the Unexamined Japanese Patent Application No. 2000-149514. However, this apparatus is the configuration for individually setting the language of the sound or the caption as described above and is only constructed so as to make setting of the language before reproduction, and trouble in setting this language was not eliminated.

Also, a configuration in which switching of a caption to a specified language is instantaneously performed is disclosed in the Unexamined Japanese Patent Application No. 2000-331464, but this apparatus is also the configuration for individually setting the language of the sound or the caption in a manner similar to the apparatus described above and the problem was not solved.

Further, an apparatus in which a GPS receiver is provided in an apparatus body and a country using the apparatus body is detected and a language of a sound, a caption and a setting menu screen is set to a language suitable for its country is disclosed in the Unexamined Japanese Patent Application No. 2000-348466, but the GPS receiver must be provided in the body and there was not a practical method from the viewpoint of a cost aspect of the apparatus body.

### SUMMARY OF THE INVENTION

An object of the invention is to provide a practical digital versatile disk player capable of improving operability and forming a main body at low cost by being constructed so that languages of a sound, a caption and a menu screen can be set at once.

A digital versatile disk player of the invention comprises the following configurations in order to solve the object.

(1) In a digital versatile disk player comprising a reading section for reading video data recorded on a digital versatile disk, sound data of plural languages associated with this video data and caption data of the plural languages, a combined video signal output member for extracting the caption data of the set language from the caption data of the plural languages read by the reading section and outputting a combined video signal in which a caption based on the caption data extracted herein is combined with video based on the video data, and a sound signal output member for extracting the sound data of the set language from the sound data of the plural languages read by the reading section and outputting a sound signal based on the sound data extracted herein, there is provided a language setting member for setting languages for the sound and the caption at once.

In this configuration, languages for the sound and the caption can be set at once by the language setting member, so that this language setting can be made simply and operability can be improved.

Also, it is unnecessary to provide a special configuration such as the GPS receiver described above (it can be handled by changing an operating control program of a CPU), so that cost of a main body does not increase and the cost is low.

(2) There are provided setting menu screen data storage member for storing setting menu screen data by the plural languages, and a setting menu screen output member for reading the setting menu screen data of the set language from the setting menu screen data stored in the setting menu screen data storage member and outputting a video signal based on the setting menu screen data read herein, and the language setting member is a member for setting languages of the setting menu screen data read from the setting menu screen data storage member in addition to the sound and the caption at once.

In this configuration, languages of the menu screen as well as the sound and the caption can also be set at once by the language setting member, so that operability can be improved more.

(3) The language setting member has a member for switching display or no display of the caption.

In this configuration, the caption is not always displayed and a user can switch display/no display of the caption as desired, so that it is convenient for the user without the need for the caption.

### BRIEF DESCRIPTION OF THE DRAWINGS

FIG. 1 is a diagram showing a configuration of a DVD player which is an embodiment of this invention;

FIG. 2 is a diagram describing data recorded on a DVD;

FIG. 3 is a diagram showing a configuration of a sound data switching section of the DVD player which is the embodiment of the invention;

FIG. 4 is a diagram showing a configuration of a caption data switching section of the DVD player which is the embodiment of the invention;

FIG. 5 is a diagram showing setting processing of a language in the DVD player which is the embodiment of the invention;

FIGS. 6A and 6B are diagrams showing a display screen example at the time of setting processing of a language in the DVD player which is the embodiment of the invention; and

FIG. 7 is a diagram showing a display screen example at the time of setting processing of a language in the DVD player which is the embodiment of the invention.

### DETAILED DESCRIPTION OF THE PREFERRED EMBODIMENTS

A digital versatile disk player (hereinafter called “DVD player”) which is an embodiment of the invention will be described below.

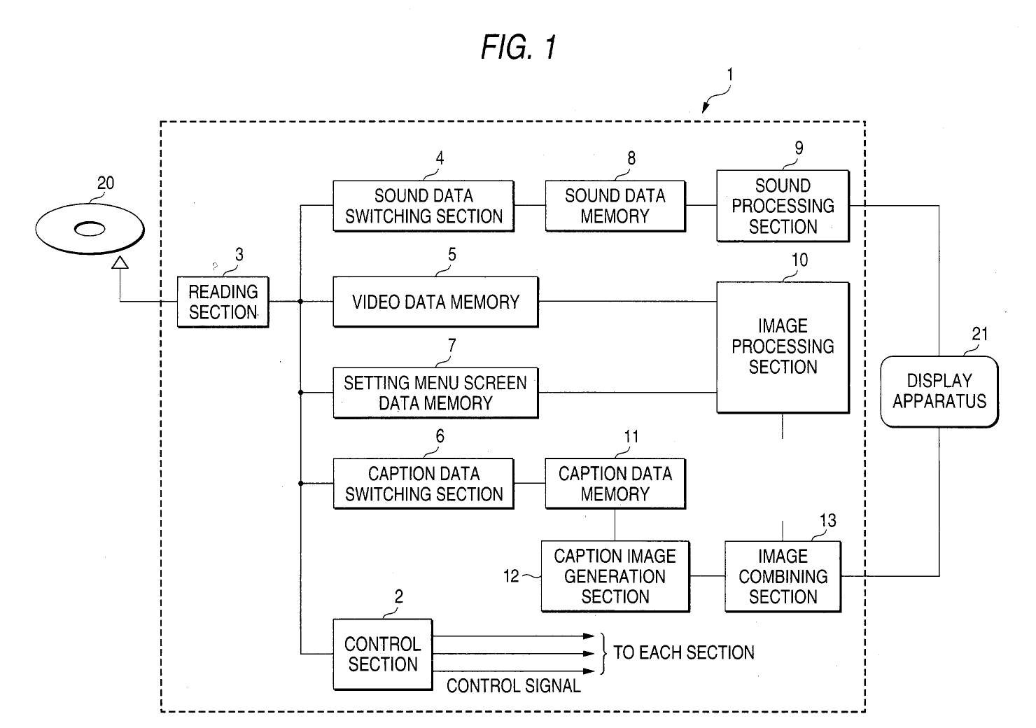

FIG. 1 is a block diagram showing a configuration of a DVD player of this embodiment. A DVD player 1 comprises a control section 2 for controlling an operation of a main body, a reading section 3 for reading data recorded on a DVD 20 set in the main body, a sound data switching section 4 for inputting sound data read by the reading section 3, video data memory 5 for storing image data read by the reading section 3, a caption data switching section 6 for inputting caption data read by the reading section 3, setting menu screen data memory 7 for storing setting menu screen data for guiding a method of a setting operation of various parameters, sound data memory 8 for storing sound data of a selected language outputted from the sound data switching section 4, a sound processing section 9 for processing sound data stored in the sound data memory 8 and outputting a sound signal, an image processing section 10 for processing image data stored in the video data memory 5 or an OSD image data memory 7, caption data memory 11 for storing caption data of a selected language outputted from the caption data switching section 6, a caption image generation section 12 for processing caption data stored in the caption data memory 11 and generating a caption image, and an image combining section 13 for combining video outputted from the image processing section 10 with a caption image outputted from the caption image generation section 12. A sound signal and an image signal outputted from the sound processing section 9 and the image combining section 13 are inputted to a display apparatus 21 and sound is outputted from a speaker of the display apparatus 21 and also an image is displayed on a screen of the display apparatus 21.

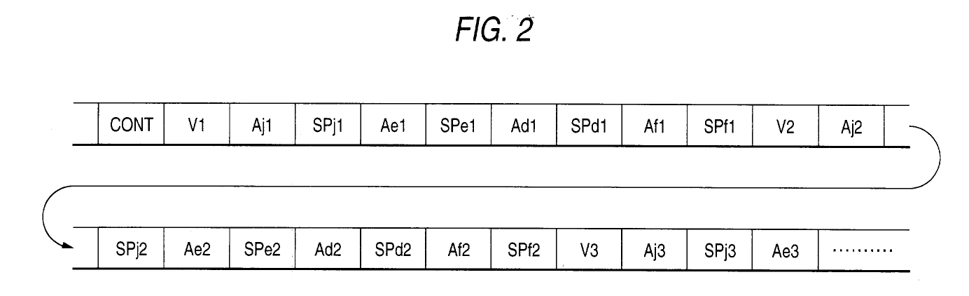

The reading section 3 has a configuration comprising a well-known pickup head, and reads various data recorded on the DVD 20. As shown in FIG. 2, video data (V*), sound data (Aj*, Ae*, Ad*, Af*), caption data (SPj*, Spe*, SPd*, SPf*) and control data (CONT) are recorded on the DVD 20 with the data mixed in one track. Also, the sound data and the caption data of plural languages such as Japanese, English, German and French are recorded on the DVD 20.

Incidentally, in FIG. 2, marks of j, e, d, f attached to the sound data and the caption data show kinds of languages, and j shows Japanese and e shows English and d shows German and f shows French.

The video data, the sound data and the caption data stored in the DVD 20 are compressed data.

The control data which the reading section 3 reads from the DVD 20 is inputted to the control section 2. This control data is data for directing reproduction timing of the video data, the sound data and the caption data read from the DVD 20. The control section 2 uses this control data for synchronizing the reproduction timing of the video data, the sound data and the caption data read from the DVD 20. Also, the control section 2 inputs a control signal to each of the other sections forming the main body.

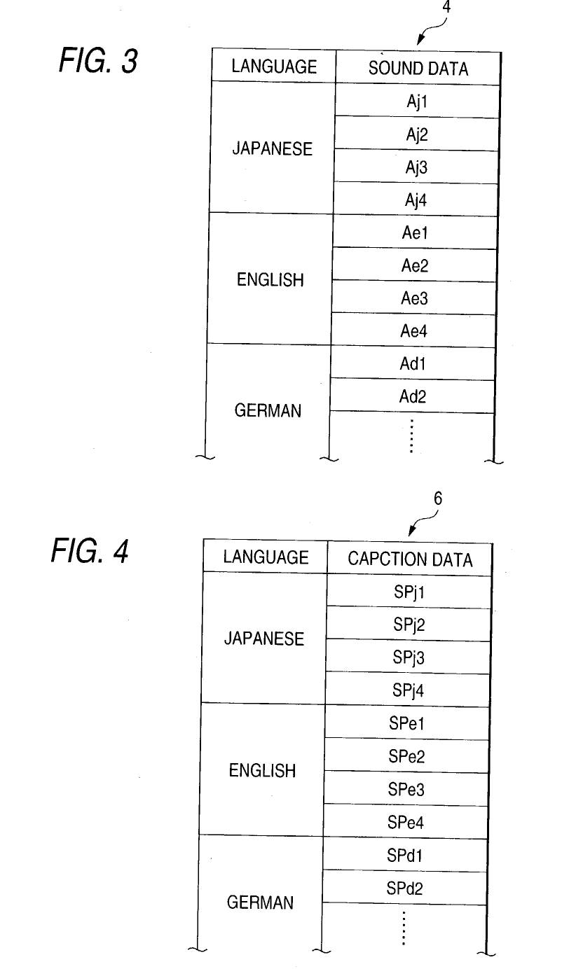

The sound data which the reading section 3 reads from the DVD 20 is inputted to the sound data switching section 4. The sound data switching section 4 has a configuration for storing the sound data which the reading section 3 reads from the DVD 20 every language as shown in FIG. 3. Also, a storage area of the sound data provided every each the language is configured so that the reproduced sound data does not remain forever. New sound data which the reading section 3 reads from the DVD 20 is stored in the storage area in which the reproduced sound data is stored.

Also, a type of a set language is inputted from the control section 2 to the sound data switching section 4. The sound data switching section 4 inputs sound data of the language of this inputted type to the sound data memory 8, and does not input sound data of the language of the other types to the sound data memory 8. Therefore, only the sound data of the language of the set type is stored in the sound data memory 8. The sound processing section 9 expands the sound data stored in the sound data memory 8 according to directions from the control section 2, and inputs this expanded sound data to the display apparatus 21.

The caption data which the reading section 3 reads from the DVD 20 is inputted to the caption data switching section 6. The caption data switching section 6 has a configuration for storing the caption data which the reading section 3 reads from the DVD 20 every language as shown in FIG. 4. Also, a storage area of the caption data provided every each the language is configured so that the reproduced caption data does not remain forever. New caption data which the reading section 3 reads from the DVD 20 is stored in the storage area in which the reproduced caption data is stored.

Also, a type of a set language is inputted from the control section 2 to the caption data switching section 6. The caption data switching section 6 inputs caption data of the language of this inputted type to the caption data memory 11, and does not input caption data of the language of the other types to the caption data memory 11. Therefore, only the caption data of the language of the set type is stored in the caption data memory 11. The caption image generation section 12 expands the caption data stored in the caption data memory 11 according to directions from the control section 2, and generates a caption image. This caption image is inputted to the image combining section 13.

Further, the video data which the reading section 3 reads from the DVD 20 is inputted to the video data memory 5. The image processing section 10 expands the video data stored in the video data memory 5 or the setting menu screen data memory 7 according to directions from the control section 2, and generates video. The image combining section 13 combines the video inputted from the image processing section 10 with the caption image inputted from the caption image generation section 12, and inputs this combined image to the display apparatus 21.

Incidentally, when an image outputted from the image processing section 10 is an image read out of the setting menu screen data memory, the image combining section 13 inputs the image outputted from the image processing section 10 without combining caption data as it is to the display apparatus 21. Also, when the image processing section 10 reads out setting menu screen data stored in the setting menu screen data memory 7, the setting menu screen data of the language directed from the control section 2 is read out.

As a result of this, the sound inputted from the sound processing section 9 is outputted while the video inputted from the image combining section 13 is displayed.

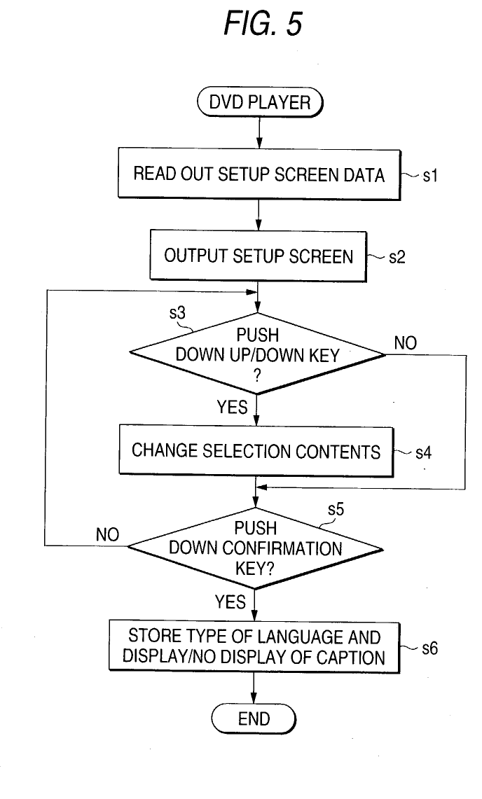

Next, processing for setting a language of a sound, a caption and a setting menu screen in the DVD player 1 of this embodiment will be described. FIG. 5 is a flowchart showing this language setting processing.

When a setup key provided in a main body is pushed down or a setup command is sent from a remote control apparatus (not shown), the DVD player 1 starts this operation.

The image processing section 10 reads setup screen data out of the setting menu screen data memory 7 (s1). In this case, the image processing section 10 reads out the setup screen data of the language set at this point in time. For example, the image processing section 10 reads out the setup screen data of English when a language presently selected is English, and reads out the setup screen data of Japanese when the language is Japanese.

The image processing section 10 processes the setup screen data read out of the OSD image data memory 7 and inputs a video signal of a setup screen to the image combining section 13. The image combining section 13 outputs the video signal of the setup screen without combining a caption image outputted from the caption image generation section 12 as described above (s2).

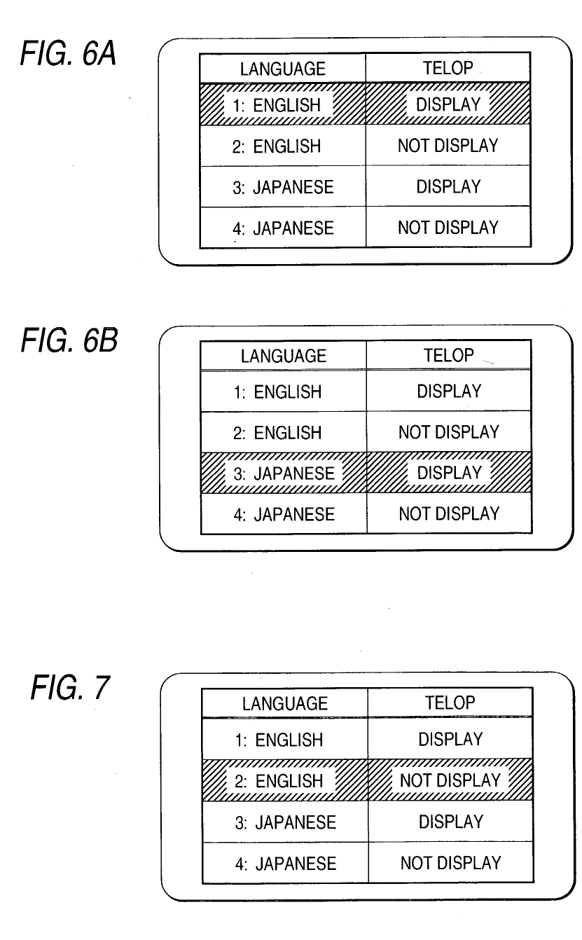

As a result of this, a setup screen shown in FIG. 6 is displayed on the display apparatus 21. FIG. 6A is a display screen example of the case that a set language is English, and FIG. 6B is a display screen example of the case that the set language is Japanese.

On a display screen of the display apparatus 21, a screen in which a type of language is associated with display/no display of a caption is displayed by the language set at this point in time as shown in FIG. 6. In FIG. 6, a portion shown by hatching is the presently set contents.

Here, the DVD player 1 changes the selection contents when an up-and-down key provided in a main body is pushed down or up-and-down directions from a remote control apparatus are given (s3, s4). For example, when a down key is operated once in a state shown in FIG. 6A, hatching is shifted to the item below by one as shown in FIG. 7. Therefore, a user can check the presently selected contents (a type of language and display/no display of a caption) by viewing a screen of the display apparatus 21.

When the user operates an up-and-down key provided in a main body of the DVD player 1 or a remote control apparatus to select a desired language type and display/no display of a caption, the user pushes down a confirmation key provided in the main body of the DVD player 1 or the remote control apparatus.

When the confirmation key provided in the main body is pushed down or a confirmation command is received from the remote control apparatus, the DVD player 1 stores the language type and display/no display of the caption selected at this point in time in the control section 2 (s5, s6), and ends the present processing.

The DVD player 1 inputs the type of language stored in the control section 2 in s6 at the time of operation to the sound data switching section 4, the caption data switching section 6 and the image processing section 10. As a result of this, the sound data switching section 4 outputs only sound data of the language of this type, and the caption data switching section 6 outputs only caption data of the language of this type. Also, the image processing section 10 reads out setting menu screen data of the language of this type in the case of reading a setting menu screen out of the setting menu screen data memory 7. Further, the control section 2 inputs display/no display of a caption to the image combining section 13. When display of the caption is inputted, the image combining section 13 outputs a video signal in which a caption image inputted from the caption image generation section 12 is combined with video inputted from the image processing section 10. In reverse, when no display of the caption is inputted, a video signal inputted from the image processing section 10 is outputted without combining the caption image inputted from the caption image generation section 12 with the video inputted from the image processing section 10.

Thus, the DVD player 1 of this embodiment can set a language of a sound, a caption and an OSD image at once, so that operability is good and a troublesome operation is not caused to a user.

Also, it is constructed so as to switch display/no display of a caption, so that a clean screen on which the caption is not displayed can be displayed on the display apparatus 21 by a simple operation.

As described above, according to the invention, and forming a main body at low cost by being constructed so that languages of a sound, a caption and further a menu screen can be set at once, so that operability of a user can be improved and these languages can be set simply.

Also, display/no display of a caption can be switched simultaneous with setting of the languages, so that a clean screen on which the caption is not displayed can be displayed on a display apparatus simply.

[FIG. 1]

2: Control Section

3: Reading section

4: Sound Data Switching Section

5: Video Data Memory

6: Caption Data Switching Section

7: Setting Menu Screen Data Memory

8: Sound Data Memory

9: Sound Processing Section

10: Image Processing Section

11: Caption Data Memory

12: Caption Image Generation Section

13: Image Combining Section

21: Display Apparatus

X1: Control Signal

X2: to Each Section

[FIG. 3]

X1: Language

X2: Japanese

X3: English

X4: German

X5: Sound Data

[FIG. 4]

X1: Language

X2: Japanese

X3: English

X4: German

X5: Caption Data

[FIG. 5]

S1: Read out Setup Screen Data

S2: Output Setup Screen

S3: Push down Up/Down Key

S4: Change Selection Contents

S5: Push down Confirmation Key

S6: Store Type of Language and Display/No Display of Caption

X1: DVD Player

X2: End

[FIG. 6B]

1: English, display

2: English, not display

3: Japanese, display

4: Japanese, not display

X1: language

X2: telop

What is claimed is:

1. A digital versatile disk player comprising:
a reading section for reading video data recorded on a digital versatile disk, sound data of plural languages associated with the video data and caption data of the plural languages,
a combined video signal output member for extracting the caption data of the set language from the caption data of the plural languages read by said reading section and outputting a combined video signal in which a caption based on the caption data extracted herein is combined with video based on the video data,
a sound signal output member for extracting the sound data of the set language from the sound data of the plural languages read by said reading section and outputting a sound signal based on the sound data extracted herein,
a setting menu screen data storage member for storing setting menu screen data by the plural languages,
a setting menu screen output member for reading the setting menu screen data of the set language from the setting menu screen data stored in said setting menu screen data storage member and outputting a video signal based on the setting menu screen data read herein, and
a language setting member for setting languages for the sound, the caption and the setting menu screen at once, said language setting member including a member for switching display or no display of the caption.

2. A digital versatile disk player comprising:
a reading section for reading video data recorded on a digital versatile disk, sound data of plural languages associated with this video data and caption data of the plural languages,
a combined video signal output member for extracting the caption data of the set language from the caption data of the plural languages read by said reading section and outputting a combined video signal in which a caption based on the caption data extracted herein is combined with video based on the video data,
a sound signal output member for extracting the sound data of the set language from the sound data of the plural languages read by said reading section and outputting a sound signal based on the sound data extracted herein, and
a language setting member for setting languages for the sound and the caption at once.

3. The digital versatile disk player as defined in claim 2, comprising:
a setting menu screen data storage member for storing setting menu screen data by the plural languages, and
a setting menu screen output member for reading the setting menu screen data of the set language from the setting menu screen data stored in the setting menu screen data storage member and outputting a video signal based on the setting menu screen data read herein, wherein
said language setting member is a member for setting languages of the setting menu screen data read from said setting menu screen data storage member in addition to the sound and the caption at once.

4. The digital versatile disk player as defined in claim 2, wherein
said language setting member includes a member for switching display or no display of the caption.
